(19) United States
(12) Patent Application Publication
(10) Pub. No.: US 2025/0088736 A1
(43) Pub. Date: Mar. 13, 2025

(54) HIGH-SPEED IMAGING APPARATUS AND ACCESSORY DEVICE FOR USE WITH THE SAME

(71) Applicant: SHIMADZU CORPORATION, Kyoto-shi (JP)

(72) Inventors: Jun KAWAI, Kyoto-shi (JP); Kaoru IHARA, Kyoto-shi (JP)

(21) Appl. No.: 18/791,559

(22) Filed: Aug. 1, 2024

(30) Foreign Application Priority Data
Sep. 11, 2023 (JP) 2023-147167

(51) Int. Cl. H04N 23/60; G01S 17/08; H04N 23/67

(52) U.S. Cl. CPC H04N 23/64; G01S 17/08; H04N 23/67

(57) ABSTRACT

A high-speed imaging apparatus is configured to capture a moving image of a high-speed phenomenon that is imperceptible to naked eyes. The apparatus is provided with an image capture unit for repeatedly acquiring an optical image from a subject as an imaging target, and a marker formation unit. The marker formation unit emits laser light toward the subject to form a line-shaped marker on the subject, the line-shaped marker passing through a point corresponding to the center position of the imaging range by the image capture unit and extending in the height direction of the main body of the apparatus.

### CROSS-REFERENCE TO RELATED APPLICATIONS

This application claims priority under 35 U.S.C. § 119 to Japanese Patent Application No. 2023-147167 filed on Sep. 11, 2023, the entire disclosure of which is incorporated herein by reference in its entirety.

### BACKGROUND OF THE INVENTION

### Field of the Invention

The present disclosure relates to a high-speed imaging apparatus for capturing a high-speed phenomenon and an accessory device used with the apparatus.

### Description of the Related Art

The following description sets forth the inventor's knowledge of the related art and problems therein and should not be construed as an admission of knowledge in the prior art.

Dedicated high-speed imaging apparatuses are used to capture high-speed imaging phenomena, such as, destruction, explosion, collision, electrical discharge, and high-speed movement of an object, which are difficult to capture with an ordinary imaging apparatus (video camera). For example, in the high-speed imaging apparatus (high-speed video camera) described in Non-Patent Document 1, it is possible to perform extremely high-speed imaging at a maximum of 10 million frames per second (10 Mfps), making it extremely powerful for detailed observation of high-speed phenomena.

### PRIOR ART DOCUMENT

### Patent Document

Patent Document 1: International Publication No. WO 2020/065815

### Non-Patent Document

Non-Patent Document 1: “High-Speed Video Camera High-Speed Video Camera Hyper Vision HPV-X2,” Shimadzu Corporation, [online], [retrieved on Sep. 8, 2023], Internet <URL: https://www.an.shimadzu.co.jp/sites/an.shimadzu.co.jp/files/pim/pim_document_file/a n_jp/brochures/20730/c220-4594.pdf>
Non-Patent Document 2: Yano, Nishikawa, “Dynamic Observation of Strain Distribution in High-Speed Tensile Testing,” Shimadzu Corporation, [online], [retrieved Sep. 8, 2023], Internet <URL: https://www.an.shimadzu.co.jp/sites/an.shimadzu.co.jp/files/pim/pim_document_file/a n_jp/applications/application_note/21335/an_01-00496-jp.pdf>

Non-Patent Document 2 and Patent Document 1 describe a method for observing the strain and fracture of an object in a tensile test using a high-speed imaging apparatus such as those described above. In this type of observation, the high-speed imaging apparatus is installed close to a testing machine, while a personal computer (PC), which is used to control the setting of imaging conditions, display, and analyze the images obtained by the imaging apparatus, is installed at a distance from the testing machine and the imaging apparatus, and the imaging apparatus and the PC are connected by a cable.

Unlike an ordinary imaging apparatus, a high-speed imaging apparatus is not equipped with a display for monitoring in its main body. Therefore, when the user (observer) adjusts the imaging range (the field of view range or the angle of view of the imaging apparatus), the user is required to adjust the angle and the position of the imaging apparatus while viewing the image displayed on the PC monitor screen in real time from a distance, or while repeatedly going back and forth between the PC monitor and the installation position of the imaging apparatus.

For these reasons, the operation of adjusting the field of view range of a conventional imaging apparatus for high-speed imaging is a rather complicated and time-consuming task. Further, when using a high-speed imaging apparatus, it is often time-consuming and costly to prepare for phenomena to be produced by the imaging target. Therefore, it is sometimes difficult or practically impossible to redo imaging, and the complexity and difficulty of adjusting the imaging range is a major psychological burden for the user.

### SUMMARY OF THE INVENTION

The preferred embodiments of the present disclosure have been developed in view of the above-mentioned and/or other problems in the related art. The preferred embodiments of the present disclosure can significantly improve upon existing methods and/or apparatuses.

The present disclosure has been made in order to solve these problems, and the main object of the present disclosure is to provide a high-speed imaging apparatus capable of easily and accurately performing the adjustment work of the field of view range of the apparatus during the imaging process.

According to one aspect of the present disclosure, a high-speed imaging apparatus configured to capture a moving image of a high-speed phenomenon that is imperceptible to naked eyes, comprises:
an image capture unit configured to repeatedly capture an optical image of a subject as an imaging target; and
a marker formation unit configured to emit laser light toward the subject to form a line-shaped marker on the subject, the line-shaped marker passing through a point corresponding to a center position of an imaging range by the image capture unit and extending in a height direction of a main body of the apparatus.

According to another aspect of the present disclosure, an accessory device for use with a high-speed imaging apparatus is configured to be attached to a main body of the high-speed imaging apparatus for capturing a moving image of a high-speed phenomenon that is imperceptible to naked eyes. The main body includes an image capture unit configured to repeatedly capture an optical image of a subject as an imaging target. The accessory device is provided with:
a marker formation unit configured to emit laser light toward the subject to form a line-shaped marker on the subject, the line-shaped marker passing through a point corresponding to a center position of an imaging range by the image capture unit and extending in a height direction of the main body of the apparatus.

In the above-described aspects of the high-speed imaging apparatus and the accessory device for use with a high-speed imaging apparatus, the marker is fixed with respect to the imaging range by the image capture unit, and when the image capture unit is moved or tilted, the marker is also moved or tilted accordingly. Therefore, according to the above-described aspects of the high-speed imaging apparatus and the accessory device for use with a high-speed imaging apparatus, the user can accurately adjust the position and/or the angle of the high-speed imaging apparatus while visually checking the marker by the laser light projected on the subject, without viewing the real-time image displayed on a display monitor placed at, for example, a distance away from the main body of the high-speed imaging apparatus. This makes it easy and accurate to perform the adjustment work so that the imaging target comes near the center of the imaging range of the high-speed imaging apparatus.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspects or features of other embodiments where applicable. The descriptions of aspects, features and/or advantages of particular embodiments should not be construed as limiting other embodiments or the claims.

### BRIEF DESCRIPTION OF THE DRAWINGS

The preferred embodiments of the present disclosure are shown by way of example, and not limitation, in the accompanying figures.

FIG. 1A and FIG. 1B are perspective diagrams each showing a high-speed imaging apparatus and a marker formed on a subject according to one embodiment of the present disclosure.

FIG. 2 is an entire diagram showing an imaging system including the high-speed imaging apparatus shown in FIG. 1.

FIG. 3 is a block diagram of this high-speed imaging apparatus, focusing on the electrical system.

FIG. 4A is a schematic diagram showing an example of a state in which a marker is illuminated on a subject (test specimen), and FIG. 4B is a schematic diagram showing a relation between the imaging range and the subject in the state described above.

FIG. 5A and FIG. 5B are schematic diagrams each showing an example of the relation between the imaging range and the subject when the posture of the high-speed imaging apparatus is changed.

FIG. 6 is an external perspective view showing a state in which an accessory device for use with a high-speed imaging apparatus, which is one embodiment of the present disclosure, is attached to the apparatus main body.

FIG. 7 is an external perspective view of the accessory device for use with a high-speed imaging apparatus.

FIG. 8 is a block diagram according to one modification of the high-speed imaging apparatus, focusing on the electrical system.

FIG. 9A and FIG. 9B are diagrams each showing a high-speed imaging apparatus according to another modification and a marker formed on a subject.

FIG. 10 is a block diagram of a high-speed imaging apparatus according to still another modification, focusing on the electrical system.

### DETAILED DESCRIPTION OF THE PREFERRED EMBODIMENTS

In the following paragraphs, some preferred embodiments of the present disclosure will be described by way of example and not limitation. It should be understood based on this disclosure that various other modifications can be made by those in the art based on these illustrated embodiments.

In this specification, the term “high-speed imaging” refers to imaging of a moving image at a frame rate of approximately 100,000 frames/second or higher.

Hereinafter, some embodiments of the high-speed imaging apparatus according to the present disclosure will be described with reference to the attached drawings.

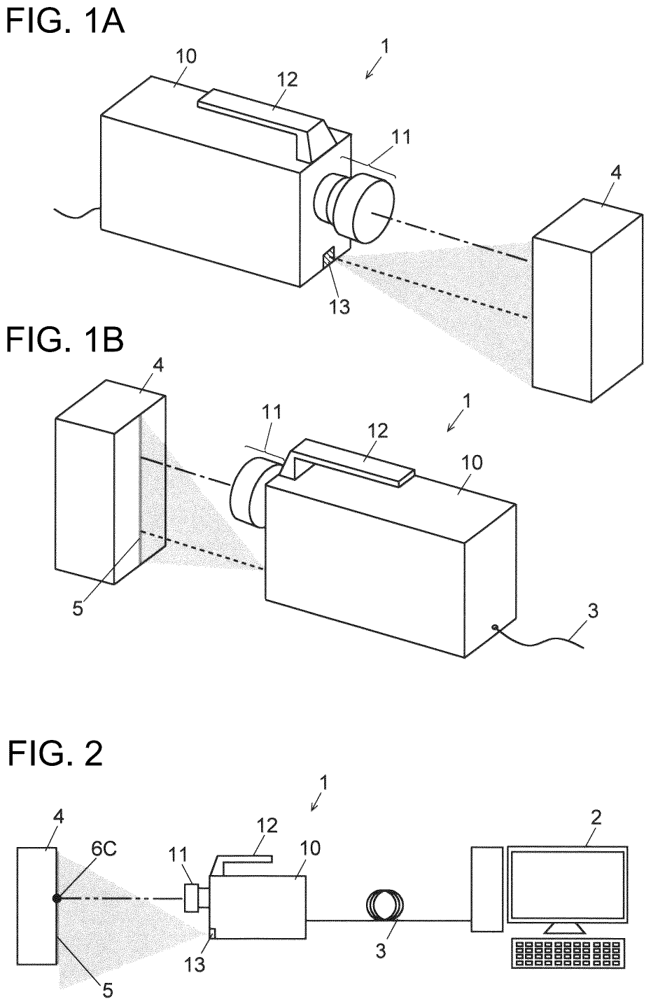

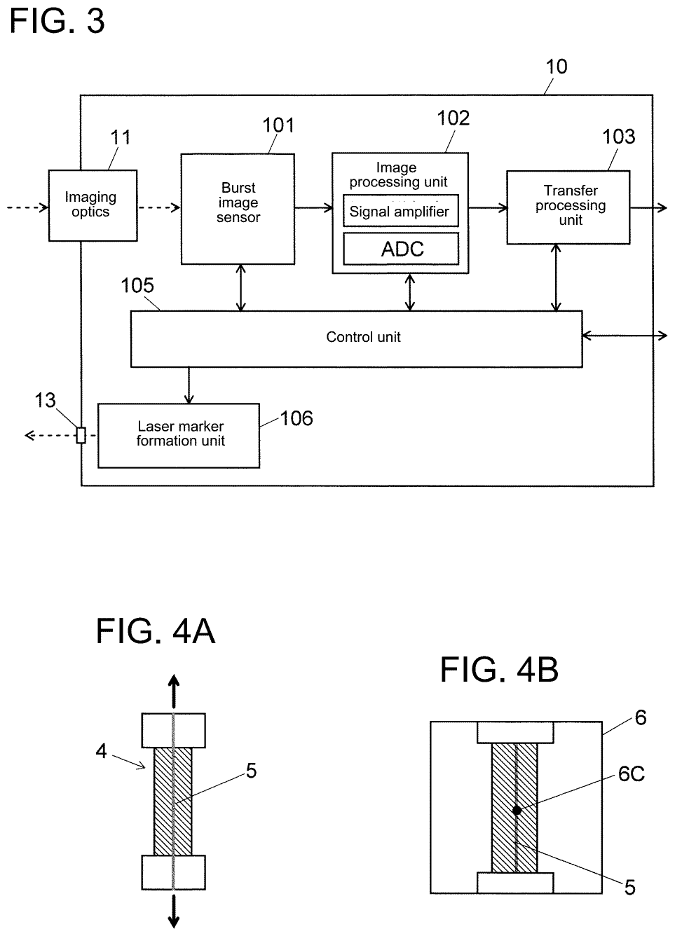

FIG. 2 is an entire diagram of an imaging system including the high-speed imaging apparatus shown in FIG. 1. FIG. 1A and FIG. 1B are perspective view each showing a high-speed imaging apparatus and a marker formed on a subject according to one embodiment of the present disclosure. FIG. 3 is a block diagram of the high-speed imaging apparatus, focusing on the electrical system.

The imaging system is designed for high-speed imaging of a subject 4 and, as shown in FIG. 2, includes a high-speed imaging apparatus 1, a personal computer (PC) 2, and a cable 3 connecting the imaging apparatus 1 and the computer 2. The PC 2 includes a PC main body with a built-in CPU and other components, an input unit such as a keyboard and pointing device, and a display unit such as a display monitor.

The high-speed imaging apparatus 1 includes an apparatus main body 10, an imaging optics 11, at least part of which protrudes forward from the apparatus main body 10, and a handle 12 for carrying the apparatus 1.

As shown in FIG. 1A, a laser light emission window 13 is provided on the front lower surface of the apparatus main body 10. When the apparatus main body 10 is viewed from the front, the laser light emission window 13 is located on a vertical line that passes through the center position of the imaging optics 11. Therefore, when the apparatus main body 10 is placed on the floor in the normal position, the laser light emission window 13 is positioned directly below the imaging optics 11.

As shown in FIG. 3, the high-speed imaging apparatus 1 is equipped with functional blocks, including an imaging optics 11, a burst image sensor 101, an image processing unit 102, a transfer processing unit 103, a control unit 105, and a laser marker formation unit 106. The image processing unit 102 includes a signal amplifier, an analog-to-digital converter (ADC), and other components. The transfer processing unit 103 includes a buffer memory and other components. The components other than the laser marker formation unit 106 can be the same as or equivalent to the components provided by conventional high-speed imaging apparatuses such as the high-speed imaging apparatus described in Non-Patent Document 1.

Note that as is the case with the apparatus described in Non-Patent Document 1, such a high-speed imaging apparatus is generally equipped with only the minimum functions necessary for high-speed imaging, and is not equipped with a display monitor for monitoring the captured image.

The burst image sensor 101 is an image sensor with a special structure for high-speed imaging. In addition to a number of photoelectric converters arranged in a two-dimensional pattern, the burst image sensor 101 incorporates a storage unit that can accumulate image signals for N (N is an integer greater than 1, such as 100) number of frames. In a typical image sensor, it is necessary to send the image signal for one frame obtained in the photoelectric converter to the outside of the sensor immediately after the image signal is acquired. In contrast, in the burst image sensor 101, it is possible to transfer the image signal for one frame obtained in the photoelectric conversion unit to the internal storage unit in a very short time through the parallel signal line. Therefore, the burst image sensor 101 can perform continuous imaging without needing to read out N frames of image signals from the sensor 101 externally.

The typical imaging operation in the above-described imaging system is as follows.

Predetermined imaging conditions, such as the imaging mode (trigger condition), the frame rate, and the exposure time, are set in advance at the PC 2 and sent to the control unit 105. When the trigger to start imaging is given externally, the burst image sensor 101 performs high-speed continuous imaging under the control of the control unit 105. When imaging begins, the optical image of the subject 4 entering through the imaging optics 11 is projected onto the light-receiving surface of the burst image sensor 101. The burst image sensor 101 stores image signals in its internal storage unit at a set frame rate. After completion of the imaging, the image signals stored in the internal storage unit of the burst image sensor 101 are sequentially read out and input to the image processing unit 102. The image processing unit 102 amplifies each input image signal and then converts it to digital data. The transfer processing unit 103 transfers the image data to the PC 2 through the cable 3 at a predetermined timing.

In the high-speed imaging using the high-speed imaging apparatus 1 as described above, the high-speed imaging apparatus 1 is usually fixed in position and angle (posture) by a dedicated holder, etc. As one example, let us consider the case in which the subject 4 is a test specimen, as shown in FIG. 4A, and high-speed imaging is performed when the test specimen set in the tensile testing machine is pulled at high speed in the vertical direction and deformed or broken, respectively (in the following description and drawings, since the subjects are test specimens, they are all marked with the reference symbol “4”).

In this case, what we want to observe is an elongated range on the test specimen 4 in the tensile direction, i.e., in the vertical direction, and it is important that the range definitely falls within the imaging range, preferably near the center of the imaging range. However, since such a high-speed imaging apparatus itself is generally not equipped with a display monitor, conventionally, the user would check the positional relation between the imaging range and the test specimen on the PC monitor screen while going back and forth between the tensile tester and the PC, and then adjust the position and the posture/orientation of the high-speed imaging apparatus so that the test specimen is positioned at an appropriate location within the imaging range.

For this reason, the adjustment work of the imaging range was quite troublesome. Further, even after the test specimen was once properly adjusted, there were cases where it moved out of the imaging range due to vibration, etc., and the imaging was performed without noticing it. In contrast, in the high-speed imaging apparatus 1 of this embodiment, the adjustment of the imaging range can be performed easily and conveniently as follows.

When the user performs a predetermined operation on the input unit of the PC 2 or operates a switch (not illustrated) provided on the apparatus main body 10, the control unit 105 drives the laser marker formation unit 106. Then, the laser light source is activated in the laser marker formation unit 106, and laser light spreading in a fan shape in the vertical direction (the height direction of the apparatus main body 10) is emitted through the laser light emission window 13, as shown in FIG. 1A, FIG. 1B, and FIG. 2. Such an approximately fan-shaped laser light emission can be realized by dispersing a narrow-diameter laser light emitted from a laser source with an appropriately shaped lens.

When the laser light is emitted through the laser light emission window 13 and hits the test specimen 4, a straight-line-shaped marker 5 is projected on the test specimen 4, as shown in FIG. 4A. The color of the laser light used can be determined appropriately, such as red or green. However, by configuring the laser light such that the user can select or change the color of the laser light, it is possible to improve the visibility of the marker 5 according to the color of the test specimen 4.

The marker 5 projected on the test specimen 4 passes through a point on the extension line of the center position of the imaging optics 11, i.e., the center position 6C of the substantially rectangular imaging range 6 that can be captured by the device 1. Therefore, as shown in FIG. 4A, when the position and the posture of the apparatus 1 are adjusted such that the marker 5 projected on the vertically elongated test specimen 4 is positioned at the approximate center of the test specimen 4 in the width direction, the center position 6C of the imaging range 6 is generally positioned at the center of the test specimen 4 in the width direction, as shown in FIG. 4B. Note that in FIG. 4B, the center position 6C is marked for illustrative purposes only, and is not actually visible.

As described above, with this high-speed imaging apparatus 1, the position and the orientation of the high-speed imaging apparatus 1 can be easily adjusted such that the observation target object is positioned at the approximate center of the imaging range 6 by using the marker 5 projected on the subject 4, such as a test specimen. As a result, it becomes unnecessary to check the positional relation between the imaging range and the subject on a PC monitor located far away from the high-speed imaging apparatus 1 and the testing machine, thereby improving the efficiency of the imaging work. Furthermore, it is possible to avoid performing imaging in a state in which the imaging range and the subject are improperly positioned.

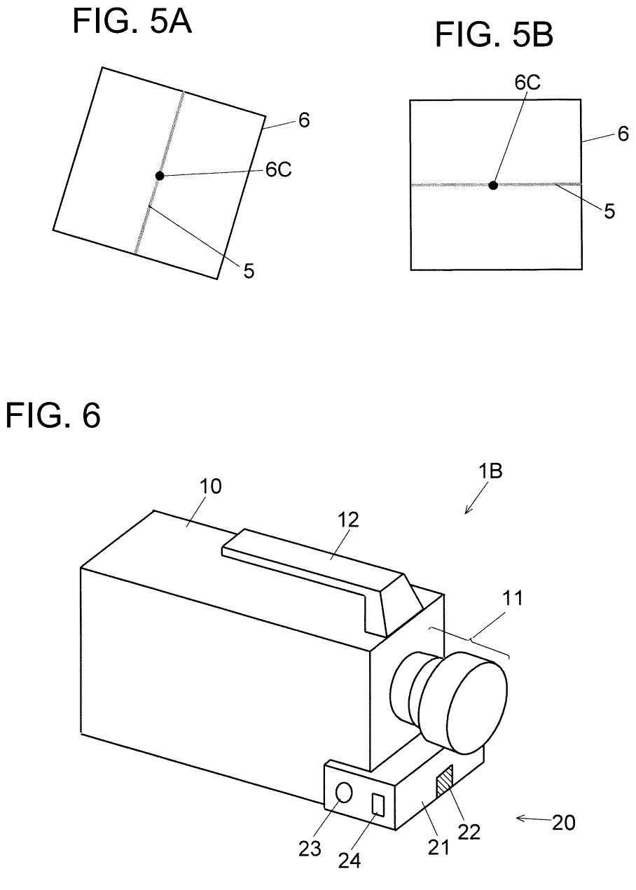

In the high-speed imaging apparatus 1 of this embodiment, since the extension direction of the marker 5 is aligned with the height direction of the apparatus main body 10, when the apparatus main body 10 is tilted, the marker 5 also tilts along with the imaging range 6, as shown in FIG. 5A and FIG. 5B. Therefore, depending on whether or not the range to be observed is elongated vertically, horizontally, or diagonally, it is sufficient to adjust the posture of the apparatus 1 appropriately.

### <Modifications>

In the high-speed imaging apparatus 1 of the above-described embodiment, the marker 5 is a straight-line-shaped marker, and although the user can grasp the center position of the imaging range 6 in the horizontal direction using the marker 5, the user cannot grasp the position of the center position 6C of the imaging range 6. Although such grasping is sufficient in the case of imaging in a tensile test on a test specimen of the shape described above, there may be cases where the center position 6C of the imaging range 6 needs to be determined accurately, depending on the purpose of the test. For such a purpose, it is advisable to project, for example, a cross-shaped marker 50 on the subject 4 instead of a straight-line-shaped marker.

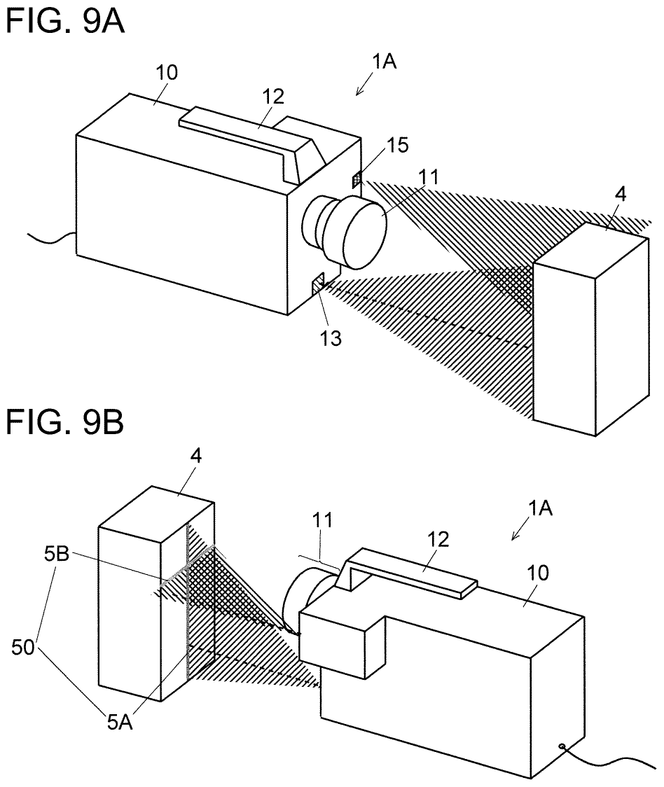

FIG. 9A and FIG. 9B are perspective views each showing a high-speed imaging apparatus 1A according to one modification and the marker 50 formed on the subject 4. In this high-speed imaging apparatus 1A, a first laser light emission window 13 is provided directly below the imaging optics 11 on the front surface of the apparatus main body 10, and a second laser light emission window 15 is provided directly beside the imaging optics 11. The laser light emitted through the first laser light emission window 13 spreads vertically (in the direction of the height of the apparatus main body 10) in a fan-shape.

The laser light emitted through the second laser light emission window 15 spreads laterally (in the direction of the width direction of the apparatus main body 10) in a fan shape. The former projects a marker 5A extending vertically on the subject 4, and the latter forms a marker 5B extending horizontally on the subject 4, and these two markers 5A and 5B are combined to form an approximately cross-shaped marker 50. The intersection point of the cross-shaped marker 50 is on the extension line of the center position of the imaging optics 11, which is the center position 6C of the imaging range 6.

In the high-speed imaging apparatus 1A according to the above-described modification, it is sufficient to adjust the position and the orientation of the apparatus 1A so that the intersection point of the marker 50 projected on the subject 4 is positioned at the part of the subject 4 that is to be most closely observed.

Further, although the high-speed imaging apparatus of the above-described embodiment simply projects the markers 5 and 50 onto the subject 4, it may incorporate a distance measurement function using laser light. Specifically, as shown in FIG. 8, the distance measurement unit 107 may be incorporated to emit pulsed laser light onto the subject 4, detect the laser light reflected back from the subject 4, and calculate the distance from the arrival time of the returned light. The calculated distance value may be displayed on a display attached to the apparatus main body 10, or it may be checked on the PC 2.

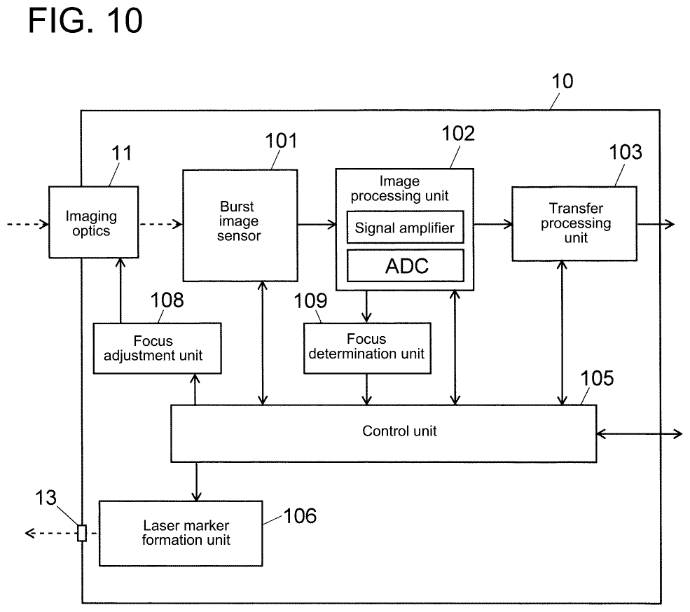

FIG. 10 is a block diagram focusing on an electrical system of a high-speed imaging apparatus according to yet another modification. In addition to the imaging apparatus according to the above-described embodiment, this imaging apparatus is equipped with a focus adjustment unit 108 for adjusting the focus and a focus determination unit 109 for determining whether or not the imaging apparatus is focused.

The focus adjustment unit 108 may be configured to include a mechanism for, e.g., moving the position of one or more lenses included in the imaging optics 11, in response to a manual operation by the user. The focus determination unit 109 is configured to determine whether or not the image signal output from the burst image sensor 101 is in focus, and can utilize a well-known method, such as, for example, a phase detection method or a contrast method. However, instead of using the burst image sensor 101, an inexpensive image sensor for determining the focus may be provided separately.

In this high-speed imaging apparatus, the control unit 105 receives from the focus determination unit 109 the determination result indicating whether or not the image to be captured at that time point is in a focused state or in an unfocused state. Then, according to the determination result, the color of the laser light generated by the laser source when driving the laser marker formation unit 106 is changed. For example, the color of the laser light is set to green when focused and red when unfocused. With this, when the user manually adjusts the focus, the user can check the colors of the markers 5 and 50 projected on the subject 4 and make adjustments so that the colors of the markers become green (focused state).

### [Embodiment of Accessory Device]

In the above-described embodiment and modifications, the function to form the markers 5 and 50 on the subject 4 is built into the apparatus main body 10. However, it is more convenient for a user who already owns a high-speed imaging apparatus that does not have the function to form markers to be able to add the function afterward rather than having to buy a new apparatus.

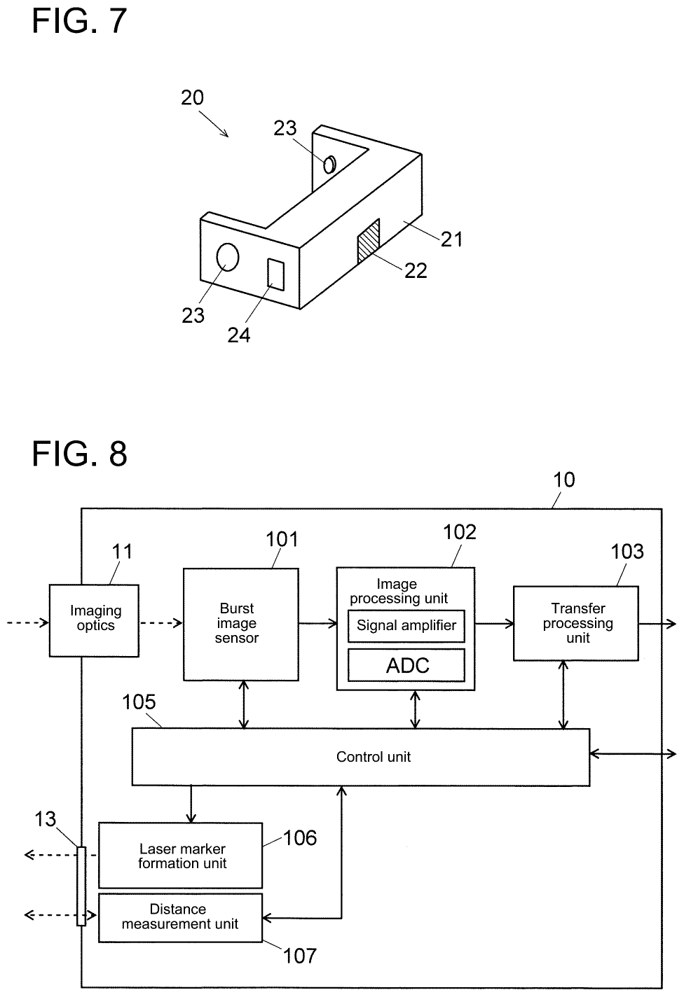

FIG. 6 is an external perspective view showing a state in which an accessory device 20, which can be used additionally with the existing high-speed imaging apparatus 1B, is attached to the apparatus main body 10. FIG. 7 is an external perspective view of the accessory device 20 itself.

This accessory device 20 is an accessory device that can be attached to the lower front side of the apparatus main body 10 of the high-speed imaging apparatus disclosed in, for example, Non-Patent Document 1.

The accessory device 20 is equipped with an approximately U-shaped main body 21 in a top view, a fixing part 23 for fixing the overhanging parts on both sides of the main body 21 to the apparatus main body 10 of the high-speed imaging apparatus 1B, a laser light irradiation window 22, and a switch 24. The main body 21 has built-in components corresponding to the laser marker formation unit 106 described above and a built-in battery, and the laser source can be turned on and off with the switch 24.

As shown in FIG. 6, when this accessory device 20 is properly attached to the apparatus main body 10, the laser light irradiation window 22 is positioned directly below the imaging optics 11 in the front view. Thus, when the laser light source is turned on by operating the switch 24, fan-shaped laser light, which is almost equivalent to that shown in FIG. 1, is emitted through the laser light irradiation window 22 toward the front, and a straight-line-shaped marker 5 is projected onto the subject 4 positioned in front of the laser light source. With this, the adjustments of the position and the orientation of the high-speed imaging apparatus 1 can be easily performed using the accessory device 20.

Needless to say, it is also possible to add the configurations described in each of the above-mentioned modifications to this accessory device 20.

Further, it should be noted that the above-described embodiment and each modification are merely examples of the present disclosure, and it is natural that any appropriate variations, modifications, additions, etc., within the scope of the intent of the present disclosure are included within the scope of the claims of this application.

### [Various Aspects]

It would be understood by those skilled in the art that the exemplary embodiments described above are specific examples of the following aspects.

### (Item 1)

According to one aspect of the present disclosure, a high-speed imaging apparatus is configured to capture moving images of a high-speed phenomenon that is imperceptible to naked eyes. The apparatus comprises:
an image capture unit configured to repeatedly capture an optical image of a subject as an imaging target; and
a marker formation unit configured to emit laser light toward the subject to form a line-shaped marker on the subject, the line-shaped marker passing through a point corresponding to a center position of an imaging range by the image capture unit and extending in a height direction of a main body of the apparatus.

### (Item 6)

According to another aspect of the present disclosure, an accessory for a high-speed imaging apparatus is configured to be attached to a main body of the high-speed imaging apparatus that captures a moving image of a high-speed phenomenon that is imperceptible to naked eyes. The image capture unit is configured to repeatedly acquire an optical image from a subject as an imaging target.

The accessory is provided with a marker formation unit configured to emit laser light toward the subject to form a line-shaped marker on the subject, the line-shaped marker passing through a point corresponding to a center position of an imaging range by the image capture unit and extending in a height direction of the main body of the apparatus.

In the high-speed imaging apparatus recited in the above-described Item 1 and the accessory device as recited in the above-described Item 6, a straight-line-shaped marker passing through the point corresponding to the center position of the imaging range (field of view range) is projected onto the subject, which is an imaging target. Thus, the user can adjust the position and the angle of the high-speed imaging apparatus precisely while visually checking the marker projected on the subject, without, for example, viewing the real-time image obtained on a display monitor placed at a distance from the high-speed imaging apparatus main body. This makes it easy and accurate to perform the adjustment work so that the imaging target comes near the center of the imaging range of the high-speed imaging apparatus.

Further, according to the accessory device particularly as recited in the above-described Item 6, a function for projecting a laser light marker on a subject can be added as a retrofit to a high-speed imaging apparatus already owned by the user. This advantage allows the user to easily and accurately adjust the imaging range while keeping costs down.

### (Item 2)

In the high-speed imaging apparatus as recited in the above-described Item 1, it may be configured such that the image capture unit includes an imaging optics for capturing light arriving from the subject, and the marker formation unit includes a laser light emission unit that is aligned with the imaging optics in the height direction of the main body of the apparatus when the imaging optics is viewed from a front.

As the method of “forming a straight-line-shaped marker by the laser light passing through the point corresponding to the center position of the imaging range by the image capture unit and extending in the height direction of the high-speed imaging apparatus main body,” it is conceivable to employ a method of “emitting laser light through the imaging optics that captures optical images from the subject, for example, coaxially with the optical system.” In contrast, according to the high-speed imaging apparatus as recited in the above-described Item 2, it is possible to easily add a marker formation unit without changing the configuration of the optical system for imaging, thereby reducing the cost of designing and producing the apparatus.

### (Item 3)

In the high-speed imaging apparatus as recited in the above-described Item 1, it may be configured such that the marker formation unit forms on the subject, in addition to the line-shaped marker by the laser light passing through the point corresponding to the center position of the imaging range and extending in the height direction of the main body of the apparatus, a line-shaped marker by laser light passing through the point corresponding to the center position of the imaging range and extending in a width direction of the main body of the apparatus.

According to the high-speed imaging apparatus as recited in the above-described Item 3, it is possible to easily adjust the position and the orientation of the imaging apparatus so that a narrow part of the area on the subject comes to be near the center of the imaging range.

### (Item 4)

In the high-speed imaging apparatus as recited in the above-described Item 1, it may be configured to further comprise a distance measurement unit configured to measure a distance between the apparatus and the subject by using laser light.

According to the high-speed imaging apparatus as recited in the above-described Item 4, it is possible to easily determine the distance to the subject without the need for a separate laser range-finder or a similar device.

### (Item 5)

In the high-speed imaging apparatus as recited in the above-described Item 1, it may be configured to further comprise
a focus adjustment unit configured to adjust a focus of an image captured by the image capture unit; and
a focus determination unit configured to determine whether or not it is in a focused state,
wherein the marker formation unit changes a color of the laser light to be emitted according to a determination result by the focus determination unit.

According to the high-speed imaging apparatus as recited in Item 5, it is possible to perform focusing work easily and accurately by using markers projected on the subject.

While the present disclosure may be embodied in many different forms, a number of illustrative embodiments are described herein with the understanding that the present disclosure is to be considered as providing examples of the principles of the present disclosure, and such examples are not intended to limit the present disclosure to preferred embodiments described herein and/or illustrated herein.

### DESCRIPTION OF REFERENCE SYMBOLS

1, 1A: High-speed imaging apparatus
10: Apparatus main body
101: Burst image sensor
102: Image processing unit
103: Transfer processing unit
105: Control unit
106: Laser marker formation unit
107: Distance measurement unit
108: Focus adjustment unit
109: Focus determination unit
11: Imaging optics
12: Handle
13, 15: Laser light emission window
2: PC
3: Cable
4: Subject (test specimen)
5, 5A, 5B, 50: Marker
6: Imaging range
6C: Center position
20: Accessory device
21: Main body
23: Fixing part
22: Laser light irradiation window
24: Switch

1. A high-speed imaging apparatus configured to capture a moving image of a high-speed phenomenon that is imperceptible to naked eyes, the apparatus comprising:
an image capture unit configured to repeatedly capture an optical image of a subject as an imaging target; and
a marker formation unit configured to emit laser light toward the subject to form a line-shaped marker on the subject, the line-shaped marker passing through a point corresponding to a center position of an imaging range by the image capture unit and extending in a height direction of a main body of the apparatus.

2. The high-speed imaging apparatus as recited in claim 1,
wherein the image capture unit includes an imaging optics for capturing light arriving from the subject, and
wherein the marker formation unit includes a laser light emission unit that is aligned with the imaging optics in the height direction of the main body of the apparatus when the imaging optics is viewed from a front.

3. The high-speed imaging apparatus as recited in claim 1,
wherein the marker formation unit forms on the subject, in addition to the line-shaped marker by the laser light passing through the point corresponding to the center position of the imaging range and extending in the height direction of the main body of the apparatus, a line-shaped marker by laser light passing through the point corresponding to the center position of the imaging range and extending in a width direction of the main body of the apparatus.

4. The high-speed imaging apparatus as recited in claim 1, further comprising:
a distance measurement unit configured to measure a distance between the apparatus and the subject by using laser light.

5. The high-speed imaging apparatus as recited in claim 1, further comprising:
a focus adjustment unit configured to adjust a focus of an image captured by the image capture unit; and
a focus determination unit configured to determine whether or not it is in a focused state,
wherein the marker formation unit changes a color of the laser light to be emitted according to a determination result by the focus determination unit.

6. An accessory device for use with a high-speed imaging apparatus, the accessory device being configured to be attached to a main body of the high-speed imaging apparatus for capturing a moving image of a high-speed phenomenon that is imperceptible to naked eyes, the main body including an image capture unit configured to repeatedly capture an optical image of a subject as an imaging target, the accessory device comprising:
a marker formation unit configured to emit laser light toward the subject to form a line-shaped marker on the subject, the line-shaped marker passing through a point corresponding to a center position of an imaging range by the image capture unit and extending in a height direction of the main body of the apparatus.
